(19) United States
(12) Patent Application Publication
(10) Pub. No.: US 2026/0010117 A1
(43) Pub. Date: Jan. 8, 2026

(54) IMAGE FORMING APPARATUS

(71) Applicant: CANON KABUSHIKI KAISHA, Tokyo (JP)

(72) Inventors: TOMOKI FUJIKAWA, Shizuoka (JP); NORIYUKI MONDEN, Meridian, ID (US); TADASHI FUKUMURO, Shizuoka (JP)

(21) Appl. No.: 19/259,848

(22) Filed: Jul. 3, 2025

(30) Foreign Application Priority Data
Jul. 4, 2024 (JP) 2024-108126

(51) Int. Cl. G03G 21/18; G03G 15/00; G03G 15/01; G03G 15/02; G03G 21/16

(52) U.S. Cl. CPC G03G 21/1857; G03G 15/0121; G03G 15/0131; G03G 15/0189; G03G 15/0283; G03G 15/5016; G03G 15/5054; G03G 15/556; G03G 21/1633; G03G 21/1814; G03G 21/1889

(57) ABSTRACT

An image forming apparatus on which cartridges are dismountably mounted includes a motor and driving members. A controller performs an initial operation in which the driving members are driven by the motor in a state in which a new cartridge is mounted on the casing before performing image forming operation and performs a resolving operation to stop the initial operation when an overload state of the motor is detected during performing the initial operation in a state in which at least two new cartridges are mounted on a casing, to determine a target cartridge, and to display to be taken out the target cartridge from the casing. The controller determines the target cartridge so that at least one new cartridge is left in the casing in a case in which the target cartridge is taken out from the casing.

### BACKGROUND

### Field of the Technology

The present invention relates to an image forming apparatus, for example, an image forming apparatus using an electrophotographic type.

### Description of the Related Art

Japanese Laid-Open Patent Application (JP-A) 2015-072457 proposes a configuration in which a plurality of process cartridges in a full-color printer are driven simultaneously by a single motor. Because such printers have a large number of process cartridges, a large torque is required for the motor when installing a new process cartridge, and depending on transportation and storage conditions, toner inside the process cartridge may harden and prevent the process cartridge from being driven. In Japanese Laid-Open Patent Application (JP-A) 2018-197785, in order to deal with such a case, it has been proposed to display on a display unit an operation to shake the process cartridge in a case in which the process cartridge cannot be driven. By having the user shake the process cartridge in accordance with the display, toner clumps inside the process cartridge can be dissolved, allowing the process cartridge to drive normally when the process cartridge is returned to the printer main body.

In a case in which a new process cartridge is mounted and cannot be driven, it may be possible to drive the new process cartridge if the load on the motor can be reduced.

### SUMMARY

An object of the present invention is to reduce a load on a motor that drives a plurality of process cartridges in order to drive a new process cartridge.

In order to solve the above problem, the present invention has the following configuration.

According to an aspect of the present invention, there is provided an image forming apparatus on which cartridges are dismountably mounted and capable of performing image forming operation to a recording material, the image forming apparatus comprising: a casing on which the cartridges are dismountably mounted; a motor; driving members configured to be driven by the motor, each of the driving members being engaged with each of the cartridges and being configured to drive each of the cartridges; and a controller configured to control the motor and perform an initial operation in which the driving members are driven by the motor in a state in which at least one new cartridge is mounted on the casing before performing the image forming operation, wherein the controller is capable of performing the initial operation in a first state in which the same number of the cartridges as that of the driving members are mounted on the casing and in a second state in which a smaller number of the cartridges than that of the driving members are mounted on the casing, wherein the controller performs a resolving operation to stop the initial operation when an overload state of the motor is detected during performing the initial operation in a state in which at least two new cartridges are mounted on the casing, to determine at least one target cartridge, and to display information relating to taking out the at least one target cartridge from the casing to a display portion, and wherein the controller determines the at least one target cartridge so that at least one new cartridge is left in the casing in a case in which the at least one target cartridge is taken out from the casing.

Further features of the present invention will become apparent from the following description of exemplary embodiments with reference to the attached drawings.

### BRIEF DESCRIPTION OF THE DRAWINGS

FIG. 1 is a sectional view showing an example of a configuration of an image forming apparatus of embodiments 1 to 4.

Part (a) of FIG. 2 is a block diagram showing a hardware configuration of embodiments 1 to 3 and part (b) of FIG. 2 is a block diagram showing a control configuration of embodiments 1 to 3.

FIG. 3 is a flow chart showing a process for determining a target station according to embodiment 1.

FIG. 4 is a flow chart showing a process for determining the target station according to embodiment 2.

FIG. 5 is a flow chart showing a process for determining the target station according to embodiment 3.

Part (a) of FIG. 6 is a diagram showing a hardware configuration of embodiment 4 and part (b) of FIG. 6 is figure showing a modification of embodiment 4.

FIG. 7 is a flow chart showing a process cartridge presence/absence detection process according to embodiment 4.

### DESCRIPTION OF THE EMBODIMENTS

Hereinafter, preferred embodiments of the present invention will be described in detail with reference to the accompanying drawings.

### Embodiment 1

### <Configuration of Image Forming Apparatus>

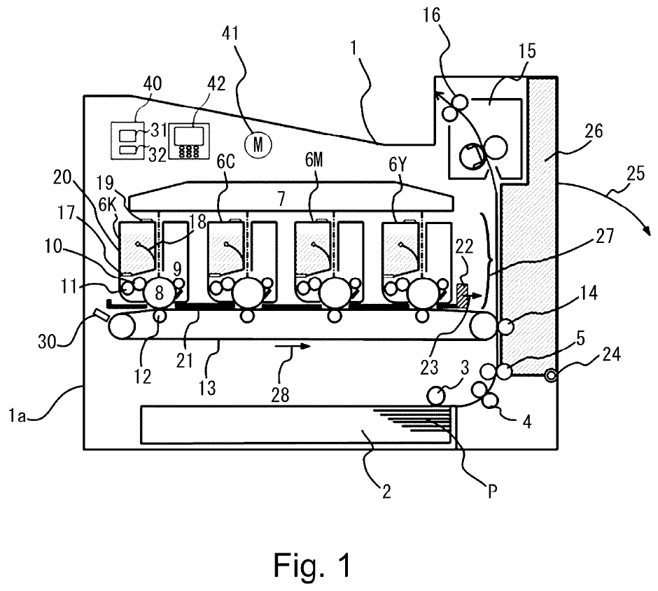

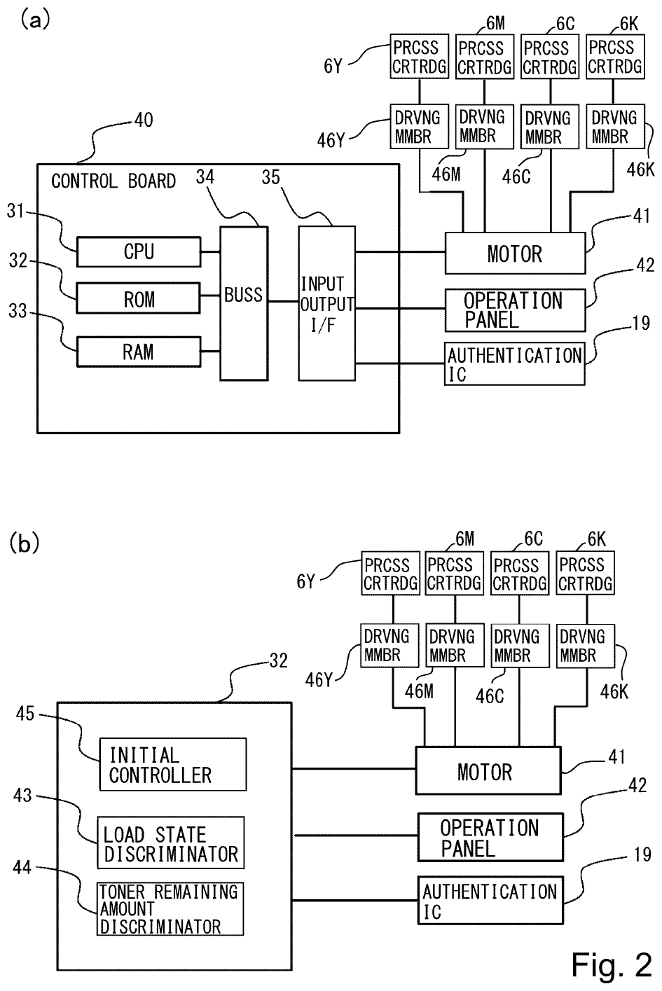

Hereinafter, embodiments for carrying out the present invention will be described in detail with reference to the drawings. FIG. 1 is a sectional view showing a configuration of an image forming apparatus of the electrophotographic type, and the configuration and basic operations of the image forming apparatus will be described with reference to FIG. 1. An image forming apparatus 1 includes detachable process cartridges 6Y (yellow), 6M (magenta), 6C (cyan), and 6K (black) provided at stations corresponding to the respective colors. These four process cartridges have the same structure, but differ in that they form images using toners of different colors. Hereinafter, Y, M, C, and K will be omitted unless necessary. A plurality of process cartridges 6 are dismountably mounted on a casing (main assembly) 1a of the image forming apparatus 1.

The process cartridges 6 include a photosensitive drum 8 as a photosensitive member, a charging roller 9 as a charging means, a developing roller 10, a toner supply roller 11, a sealing member 17, a stirring member 18, a toner container 20, and an authentication IC 19. The developing roller 10 applies toner to the photosensitive drum 8. The toner container 20 as a toner accommodating portion accommodates the toner to be applied by the developing roller 10 to the photosensitive drum 8. The sealing member 17 is attached to prevent the toner in the toner container 20 from being supplied to the developing roller 10 when the process cartridge 6 is in a new state. That is, the sealing member 17 seals a toner supply port from the toner container 20 to the developing roller 10 so as not to supply the toner from the toner container 20 to the developing roller 10.

The authentication IC 19 is a memory member (memory) that memorizes information relating to each of the plurality of process cartridges 6. The authentication IC 19 is attached to each of the process cartridges 6 (19Y, 19M, 19C, 19K), and an initial control unit 45 described later can write and read data through communication. The authentication IC 19 memorizes new product data, data indicating the color of the toner, data indicating toner capacity of the process cartridges 6 in the new state, and the like. The new product data is, for example, 1-bit data in which “1” indicates a process cartridge 6 in the new state and “0” indicates a state in which a process cartridge 6 has been driven at least once. Data for the new state “1” is memorized at the time of factory shipment. The toner capacity in the new state may be, for example, large capacity, medium capacity, or small capacity. In an embodiment 1, in a case in which the initial control unit 45 can access each authentication IC 19, it is determined that a process cartridge 6 is mounted on each station. More specifically, if the authentication IC 19 can be accessed (is in a connected state), it is determined that the process cartridge is mounted, and if the authentication IC 19 cannot be accessed (is in a disconnected state), it is determined that the process cartridge is not mounted. Incidentally, hereinafter, a process cartridge 6 in the new state will be referred to as a “new cartridge”.

The stirring members 18 included in each of the four process cartridges 6 are each driven by a motor 41 as a driving source. Further, the sealing members 17 included in each of the four process cartridges 6 are unsealed by a driving force of the motor 41. That is, the motor 41 is the driving source that drives the four process cartridges 6. More specifically, the motor 41 has a plurality of driving members 46 (46Y, 46M, 46C, 46K), and each of the driving members 46 engages with each of the plurality of process cartridges 6 to drive each of the plurality of process cartridges 6 (see FIG. 2). That is, the driving force of the motor 41 is transmitted to the stirring members 18 and the sealing members 17 via the driving members 46. Incidentally, the motor 41 may also drive the developing roller 10 and the toner supply roller 11. Further, the motor 41 may also drive the photosensitive drum 8.

The stirring members 18 driven by the motor 41 rotate to stir the toner in the toner container 20, and supply toner to the toner supply roller 11. The motor 41 is, for example, configured with a DC brushless motor, and has a hall element (not shown) as a sensor for detecting a position (phase) of a rotor, and the hall element outputs an FG pulse signal at a period proportional to a number of rotations of the rotor. This allows a CPU 31 described later to obtain a number of rotations (rpm) of the motor 41.

In an image forming operation of the image forming apparatus 1, a toner image of each color is formed on the photosensitive drum 8 by a general electrophotographic process using the toner supply roller 11, the developing roller 10, the charging roller 9, the photosensitive drum 8, and a laser unit 7. The toner images of the respective colors are superimposed (primary transfer) on an intermediary transfer belt 13 (on an intermediary transfer body) as an intermediary transfer member by a primary transfer roller 12, and the intermediary transfer belt 13 moves in a direction of an arrow 28. A recording medium P is conveyed from a paper feed cassette 2 by a paper feed roller 3, a conveyance roller 4, and a registration roller 5, and the toner image formed and born on the intermediary transfer belt 13 is transferred to the recording medium P by a secondary transfer roller 14 (secondary transfer). The unfixed toner image on the recording medium P is fixed by a fixing unit 15, and the recording medium P is discharged from a discharge roller 16.

The image forming apparatus 1 includes a control board 40, an operation panel 42, and a density sensor 30. The operation panel 42 as a display unit can provide various displays to the user. For example, in a case in which a toner remaining amount in a process cartridge 6 becomes low, an instruction to replace the process cartridges 6 with a new cartridge is displayed on the operation panel 42. Incidentally, an external device connected to the image forming apparatus 1 may be used as the display unit.

The image forming apparatus 1 is provided with an open/close portion 26 (hatched portion) which rotates in a direction of an arrow 25 with a hinge portion 24 as a support shaft, and a cartridge tray 21 (tray) which supports the process cartridges 6 and has a handle 22 attached thereto. The open/close portion 26 is movable to a closing position for covering an opening portion 27 (opening), and an opening position for exposing the opening portion 27. When the instruction to replace the process cartridge 6 is notified on the operation panel 42, the user opens the open/close portion 26, holds the handle 22, and pulls the cartridge tray 21 in a direction of an arrow 23. This exposes the process cartridges 6 in the order of Y, M, C, and K from the opening portion 27 so that they can be replaced. Incidentally, an open state (opening position) and a closed state (closing position) of the open/close portion 26 can be detected by a door sensor (not shown). A density sensor 30 is provided in a position where the density sensor 30 can detect the surface of the intermediary transfer belt 13 or the four-color toner images superimposed on the intermediary transfer belt 13.

### <Hardware Configuration>

The hardware configuration will be described with reference to part (a) of FIG. 2. The CPU 31, a ROM 32, a RAM 33, a bus 34, and an input/output I/F 35 are mounted on the control board 40 as a control means (controller). The CPU (arithmetic processing unit) 31 loads programs and various data from the ROM (read-only memory) 32, and executes the programs by using the RAM (random access memory) 33 as a working area. The CPU 31 can access the input/output I/F 35 via the bus 34 which is bidirectionally accessible. The motor 41, the operation panel 42, and the authentication IC 19 are connected to the input/output I/F 35. The CPU 31 controls these devices via the input/output I/F 35. The motor 41 drives each process cartridge 6 via each driving member 46. Incidentally, devices connected to the control board 40 are not limited to these devices.

### <Initial Setting Operation of Process Cartridges>

The control configuration of an initial setting operation will be described with reference to part (b) of FIG. 2. The initial control unit 45, a load state determination unit 43, and a toner remaining amount determination unit 44 are programs stored in the ROM 32. The CPU 31 loads these programs from the ROM 32 and executes the programs by using the RAM 33 as a working area.

The CPU 31 controls the motor 41 to perform the initial setting operation (initial operation) in which the plurality of driving members 46 are driven by the motor 41 in a state in which at least one new cartridge is mounted on the casing 1a before the image forming operation is performed. The CPU 31 is capable of performing the initial setting operation in a first state in which the same number of process cartridges 6 as that of the plurality of driving members 46 are mounted on the casing 1a, and in a second state in which a smaller number of process cartridges 6 than that of the plurality of driving members 46 are mounted on the casing 1a. When the image forming apparatus 1 is in the first state, the image forming apparatus 1 can perform the image forming operation on the recording medium P. That is, the first state can be said to be a state in which the image forming apparatus 1 is normally used. On the other hand, the number of process cartridges 6 mounted on the casing 1a of the image forming apparatus 1 is smaller when the image forming apparatus 1 is in the second state than when the image forming apparatus 1 is in the first state.

The CPU 31 is capable of performing a resolving operation in the first state in a case in which an overload state, described later, is detected during performing the initial setting operation, and in the second state in a case in which the overload state is detected during performing the initial setting operation. The resolving operation here refers to an operation in which at least one target cartridge, described later, is determined, and the initial control unit 45 displays on the operation panel 42 information relating to taking out the at least one target cartridge from the casing 1a. The CPU 31 is capable of performing a judging operation to determine whether or not the image forming apparatus 1 is in the first state. In a case in which the resolving operation is performed, the CPU 31 can perform the judging operation after performing the initial setting operation.

When even one process cartridge 6 is mounted on the image forming apparatus 1 and the open/close portion 26 is closed, the initial control unit 45 accesses the authentication IC 19 and confirms the new product data in the authentication IC 19. If the mounted process cartridge 6 is new, the initial control unit 45 performs the initial setting operation. That is, the motor 41 is driven at 1000 rpm to drive the plurality of driving members 46. The transmission of the driving force of the motor 41 via the driving members 46 drives the stirring members 18, and an operation is performed in which toner accommodated in the toner container 20 is stirred (hereinafter referred to as a stirring operation). Further, for a new process cartridge 6, the stirring operation and an unsealing operation in which the sealing member 17 is unsealed are performed. After a predetermined time (for example, one minute) has elapsed, the initial control unit 45 stops the motor 41 and ends the initial setting operation. After the initial setting operation is completed, the initial control unit 45 updates the new product data memorized in the authentication IC 19 from “1” which indicates the new state to “0” which indicates a driven state.

In a case in which an overload is applied to the motor 41 during the initial setting operation, the initial control unit 45 performs an operation which safely stops the device so that the process cartridge 6 and the image forming apparatus 1 do not malfunction. Part (b) of FIG. 2 is a block diagram for explaining the load state determination unit 43 which determines the load state of the motor 41. The load state determination unit 43 obtains, for example by calculation, the speed of the motor 41 based on the period of the FG pulse signal outputted from the motor 41. During the initial setting operation, if the speed of the motor 41 continuously becomes less than 500 rpm for 100 msec, or in other words, if the speed of the motor 41 continuously becomes less than a predetermined value, the load state determination unit 43 determines that the motor 41 is overloaded and stops the motor 41. More specifically, the CPU 31 stops the initial setting operation in a case in which an overload state of the motor 41 is detected during performing the initial setting operation in a state in which at least two new cartridges are mounted on the casing 1a. If an overload state is detected in a state with a new cartridge mounted on the image forming apparatus 1, the initial control unit 45 notifies the operation panel 42 of a failure in the image forming apparatus 1.

### <Notification of Instruction to Take Out Process Cartridge>

By reducing the number of process cartridges 6 that are simultaneously driven by the motor 41, the load on the motor 41 during the initial operation can be reduced. If an overload state is detected during the initial setting operation in a case in which a plurality of new cartridges are mounted, it may be possible to take out a part of the process cartridges 6 from the casing 1a so as to drive the process cartridges 6 remaining in the casing 1a using the motor 41. On the other hand, the toner in the process cartridge 6 is loosened by performing the stirring operation and the unsealing operation. Therefore, a process cartridge 6 on which the stirring operation and the unsealing operation have been performed can be driven with a smaller force compared to a process cartridge 6 on which these operations have not been performed.

If the load on the process cartridges 6 remaining in the casing 1a is small, the possibility of the motor 41 being able to operate becomes higher when the process cartridge 6 taken out from the casing 1a is remounted on the casing 1a.

If an overload state is detected during the initial setting operation in a state in which the plurality of new cartridges are mounted, the initial control unit 45 determines which process cartridge 6 is to be taken out from the casing 1a in order to resolve the overload state. Hereinafter, the process cartridge 6 to be taken out from the casing 1a will be referred to as a target cartridge, and the station of the target cartridge will be referred to as a target station. Incidentally, the target cartridge does not have to include a new cartridge.

If the target cartridge is taken out from the casing 1a, the initial control unit 45 determines the target cartridge so that at least one new cartridge is left in the casing 1a. The initial control unit 45 notifies an instruction on the operation panel 42 for the user to take out the target cartridge. Then, the initial control unit 45 memorizes data indicating the presence of a target station in the RAM 33. Hereinafter, data indicating the presence/absence of a target station will be referred to as “target station presence/absence data”.

This maintains a state in which the initial setting operation must be performed where the process cartridge 6 has been taken out, and prevents transitioning to other controls including a printing operation (image forming operation). When the initial control unit 45 confirms that the process cartridge 6 has been taken out from the target station based on the inability to access the authentication IC 19, the initial control unit 45 performs the initial setting operation in a state in which the target cartridge in the target station has been taken out.

### <Determination of Target Station and Initial Setting Operation>

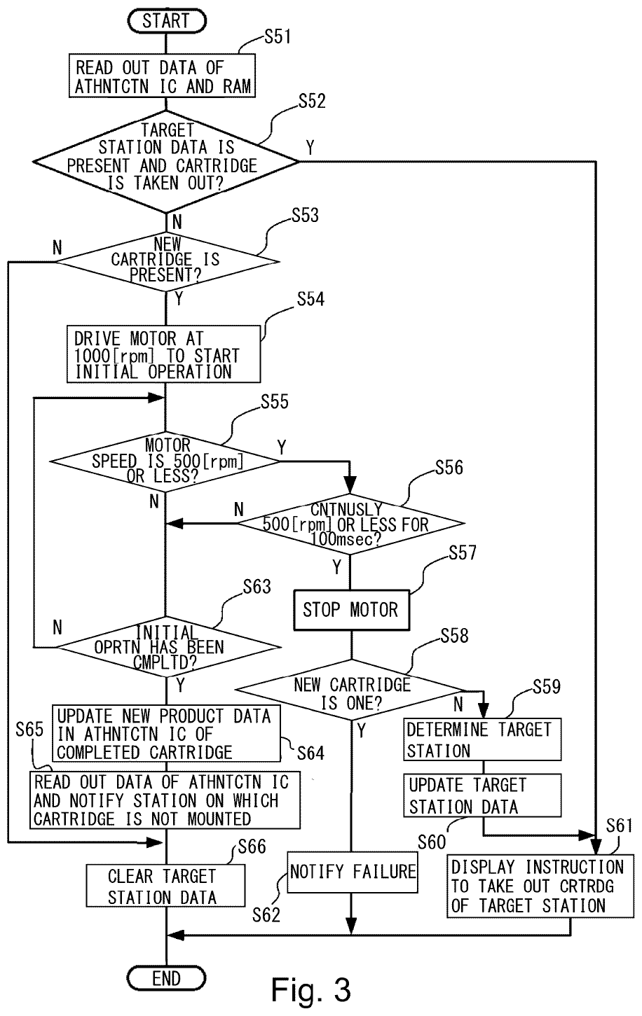

Specific operation flows will be described with reference to a flow chart in FIG. 3. In embodiment 1, when taking out the process cartridge 6, in order to reduce a pull-out amount by which the user pulls out the cartridge tray 21, the station of which a position is closest to the open/close portion 26 is preferentially chosen to be the target station. The initial control unit 45 determines the at least one target cartridge so that the at least one target cartridge includes a process cartridge 6 of which a position is closest to the open/close portion 26

Further, the target station presence/absence data memorized in the RAM 33 will be described as 4-bit data that can be set for each station, which is indicated by “1” if removal is necessary and “0” if removal is not necessary.

In step (hereinafter referred to as S) 51, the initial control unit 45 reads new product data for the process cartridge 6 from the authentication IC 19, and reads the target station presence/absence data from the RAM 33. In S52, the initial control unit 45 determines whether or not there is a target station, and whether or not the process cartridge 6 has been taken out from the target station. In S52, if either of the conditions is not met, the initial control unit 45 advances the process to S53. If the initial control unit 45 determines that there is a target station and that the process cartridge 6 has not been taken out, the process proceeds to S61.

In S53, the initial control unit 45 determines whether or not a new cartridge is present based on the new product data. In S53, if the initial control unit 45 determines that a new cartridge is not present, the process proceeds to S66. In S66, the initial control unit 45 clears the target station presence/absence data memorized in the RAM 33 to “0”. In S53, if the initial control unit 45 determines that a new cartridge is present, the process proceeds to S54. In S54, the initial control unit 45 drives the motor 41 at 1000 rpm to start the initial setting operation.

In S55, the initial control unit 45 determines, by the load state determination unit 43, whether or not the speed of the motor 41 is 500 rpm or less. In S55, if the initial control unit 45 determines that the speed of the motor 41 is not 500 rpm or less, the process proceeds to S63. In S55, if the initial control unit 45 determines that the speed of the motor 41 is 500 rpm or less, the process proceeds to S56. Here, the initial control unit 45 resets and starts a timer (not shown). In S56, the initial control unit 45 refers to the timer and determines whether or not the motor 41 has continuously been in a state of 500 rpm or less for 100 msec (whether the speed of the motor 41 has continuously been 500 rpm or less for 100 msec). In S56, if the initial control unit 45 determines, by the load state determination unit 43, that the speed has continuously become 500 rpm or less for 100 msec, or in other words, if the initial control unit 45 detects an overload state, the process proceeds to S57.

In S57, the initial control unit 45 stops the motor 41. In S58, the initial control unit 45 determines whether or not there is one new cartridge. In S58, if the initial control unit 45 determines that there is more than one new cartridge, the process proceeds to S59. In S59, the initial control unit 45 determines the station for the new cartridge of which a position is closest to the open/close portion 26 to be the target station. In S60, the initial control unit 45 updates the target station presence/absence data in the RAM 33, and the process proceeds to S61. In S61, the initial control unit 45 displays on the operation panel 42 an instruction to take out the process cartridge 6 in the target station, and ends the process.

In S58, if the initial control unit 45 determines that there is only one new cartridge, the process proceeds to S62 in which the initial control unit 45 notifies the operation panel 42 of a failure of the image forming apparatus 1, and ends the process. That is, the initial control unit 45 performs a display operation to display information relating to a failure of the motor 41 on the operation panel 42.

In S56, if the initial control unit 45 determines that the speed of the motor 41 has not continuously been 500 rpm or less for 100 msec, the process proceeds to S63. In S63, the initial control unit 45 determines whether the initial setting operation has been completed. In S63, if the initial control unit 45 determines that the initial setting operation has not been completed, the process returns to S55. In S63, if the initial control unit 45 determines that the initial setting operation has been completed, the process proceeds to S64. In S64, the initial control unit 45 updates the new product data in the authentication IC 19 of the process cartridge 6 for which the initial setting operation has been completed to “0”.

In S65, the initial control unit 45 accesses the authentication IC 19, and displays on the operation panel 42 information prompting the user to mount a process cartridge 6 on the station on which a process cartridge 6 is not mounted. In S66, the initial control unit 45 clears the target station presence/absence data to “0”, and ends the process. Incidentally, if even one process cartridge 6 is mounted on a station which is in an unmounted state, the initial control unit 45 restarts this operation flow from S51, and if the mounted process cartridge 6 is new, the initial control unit 45 performs the initial setting operation (S54). Incidentally, if at least one authentication IC 19 changes from a non-connected state to a connected state, the initial control unit 45 determines that the at least one process cartridge has been mounted.

In embodiment 1, the initial control unit 45 determines the at least one target cartridge so that the at least one target cartridge includes a part of the at least two new cartridges.

Thus, the image forming apparatus 1 can perform the initial setting operation in a state in which the target cartridge has been taken out, and the at least one new cartridge has been mounted on the casing 1a. That is, the initial setting operation is performed in the second state. At this time, since the number of process cartridges 6 driven by the motor 41 is small, an overload state of the motor 41 is less likely to occur.

Further, by performing the initial setting operation in the second state, the load on the process cartridges 6 remaining in the casing 1a can be reduced. After the initial setting operation is performed in the second state, the initial control unit 45 displays on the operation panel 42 information relating to remounting the target cartridge on the casing 1a. In a case in which the target cartridge includes a new cartridge, the initial setting operation is performed again with the target cartridge mounted on the casing 1a. That is, the operation flow shown in FIG. 3 is performed again. That is, the initial setting operation is performed in the first state. At this time, since the load on the process cartridges 6 is reduced by the initial operation in the second state, the overload state of the motor 41 is less likely to occur during the initial setting operation in the first state which is performed after the initial setting operation in the second state.

### Specific Example

TABLE 1

| | Presence/absence of initial setting operation |
|---|---|
| Y | Not complete |
| M | Complete |
| C | Not complete |
| K | Not complete |

Table 1 is a table showing an example of an implementation status of the initial setting operation according to embodiment 1.

Table 1 shows an example of the implementation status of the initial setting operation of the process cartridge 6 immediately after the replacement of the process cartridge 6 is notified on the operation panel 42 and the process cartridge 6 is replaced with a new cartridge by the user. In the case of Table 1, the initial setting operation has not been performed (not complete) for the process cartridges 6Y, 6C, and 6K, and the initial setting operation has been performed (complete) for the process cartridge 6M.

When the operation of the flow chart in FIG. 3 is applied to the case of Table 1, if the load state determination unit 43 detects an overload (Y in S56) and the motor 41 is stopped (S57), the following occurs. In S59, the new process cartridge 6Y of which a position is closest to the open/close portion 26 becomes the target station.

After the process cartridge 6Y is taken out and the open/close portion 26 is closed, the initial setting operation is performed for the remaining process cartridges 6M, 6C, and 6K. At this time, since the initial setting operation of the process cartridge 6M has been completed, the unsealing operation of the sealing member 17 has been completed, and the stirring operation is to be performed.

Similarly, if an overload state occurs and the motor 41 stops even in a state in which the process cartridge 6Y has been taken out (Y in S56 and S57), the new process cartridge 6C of which a position is closest to the open/close portion 26 becomes the target station (S59).

After the process cartridge 6C is taken out and the open/close portion 26 is closed, the initial setting operation is performed for the remaining process cartridges 6M and 6K. If an overload state is further detected in this state, since the process cartridge 6K is the only new cartridge, or in other words, there is only one new cartridge (Y in S58), a failure of the image forming apparatus 1 is notified (S62).

As described above, according to embodiment 1, if an overload is detected during the initial setting operation, the user is notified to take out the process cartridge 6, and in a state in which the new cartridge 6 in the target station has been taken out, the remaining new cartridges 6 are driven. This allows the torque of the motor 41 to be reduced, so that the initial setting operation can be performed even under load conditions such as high toner density.

In embodiment 1, a configuration has been explained wherein the cartridge tray 21 in which the process cartridges 6Y, 6M, 6C, and 6K are arranged can be pulled out in order from the open/close portion 26, but the present invention is not limited to this. For example, the process cartridges 6Y, 6M, 6C, and 6K may be configured to be pulled out in conjunction with the opening and closing of a door.

Further, the load state determination unit 43 determines whether or not the motor 41 is in an overload state based on the speed of the motor 41, but the configuration is not limited to this. For example, the load state determination unit 43 may be configured to detect a value of current flowing through the motor 41, and may determine that an overload has occurred if the value of current continuously remains at a predetermined threshold or more (above a predetermined value) for a predetermined time.

As described above, according to embodiment 1, in order to drive a new process cartridge 6, the load on the motor 41 that drives the plurality of process cartridges 6 can be reduced. As a result, it is possible to drive a new process cartridge having a high toner density without increasing the size of the motor that drives the plurality of process cartridges.

### Embodiment 2

In embodiment 1, a new process cartridge 6 was taken out and the initial setting operation was performed. In contrast, embodiment 2 differs from embodiment 1 in that, in a case in which a process cartridge 6 in the driven state (the initial setting operation has been performed) has a toner remaining amount of a predetermined value or more, a notification is issued to take out the process cartridge 6 in the driven state, and the initial setting operation is performed. A process cartridge 6 having a large toner remaining amount requires a larger torque to rotate the stirring member 18 than a process cartridge 6 having a small toner remaining amount. For this reason, the torque applied to the motor 41 when a process cartridge 6 having a large toner remaining amount is taken out is smaller than that when a process cartridge 6 having a small toner remaining amount is taken out. By using this method, it is possible to reduce the frequency of performing the initial setting operation when the process cartridge 6 taken out by the user is remounted.

The description of contents similar to those in embodiment 1 will be omitted.

The ROM 32 stores a program for the toner remaining amount determination unit 44 which determines the toner remaining amount of each process cartridge 6. The CPU 31 loads the ROM 32 and uses the RAM 33 as a working area to execute the program. Information on toner consumption for image data is stored in advance in the ROM 32, and the toner remaining amount determination unit 44 determines the toner remaining amount from the image data to be printed. The determination result by the toner remaining amount determination unit 44 is set to a value that changes according to the toner remaining amount, with the toner remaining amount in the new state being 100%. Incidentally, in embodiment 2, the toner remaining amount is obtained based on the toner consumption for the image data, but the present invention is not limited to this. For example, other detection methods may be used, such as detecting the toner remaining amount by disposing a detecting portion in an accommodating portion that accommodates toner.

### <Determination of Target Station>

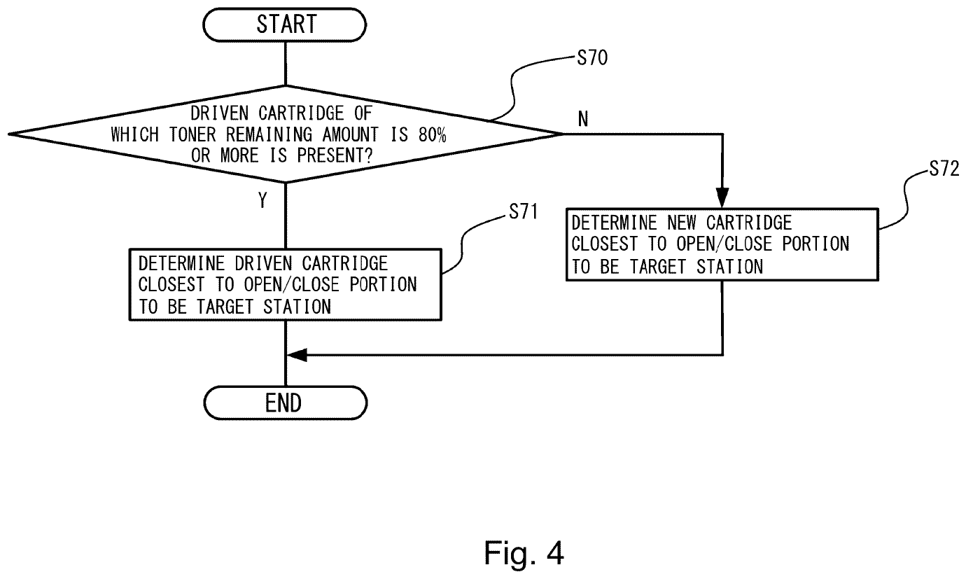

The initial setting operation of embodiment 2 differs from that of embodiment 1 in the determination method of the target station (S59 in the flow chart in FIG. 3). The determination method of the target station is determined using the flow chart in FIG. 4. If S58 in FIG. 3 determines that there is a plurality of process cartridges 6, the process for S70 in FIG. 4 is executed.

In S70, the initial control unit 45 determines, by the toner remaining amount determination unit 44, whether or not there is a driven (initial setting operation complete) process cartridge 6 (driven product) having a toner remaining amount of 80% or more. In S70, if the initial control unit 45 determines that there is a driven product, the process proceeds to S71. In S71, the initial control unit 45 determines the station on which is mounted a driven product having a toner remaining amount of 80% or more of which a position is closest to the open/close portion 26 to be the target station, and ends the process. Incidentally, after this, steps S60 and onward in FIG. 3 are executed.

In S70, if the initial control unit 45 determines that a driven process cartridge 6 having a toner remaining amount of 80% or more is not present, the process proceeds to S72. In S72, the initial control unit 45 determines the station on which is mounted a new cartridge of which a position is closest to the open/close portion 26 to be the target station, and ends the process. Incidentally, after this, steps S60 and onward in FIG. 3 are executed.

In embodiment 2, the initial control unit 45 determines the at least one target cartridge so that, of cartridges that have completed the initial setting operation, the at least one target cartridge includes a part of cartridges of which a toner remaining amount is a predetermined value or more.

### Specific Example

TABLE 2

| | Presence/absence of initial setting | |
|---|---|---|
| | operation | Toner remaining amount |
| Y | Not complete | 100% |
| M | Complete | 80% |
| C | Not complete | 100% |
| K | Complete | 40% |

Table 2 is a table showing a relationship between the implementation status of the initial setting operation and the toner remaining amount in embodiment 2.

Table 2 shows an example of the implementation status of the initial setting operation and the toner remaining amount of the process cartridge 6 immediately after the replacement of the process cartridge 6 is notified on the operation panel 42 and the process cartridge 6 is replaced with a new cartridge by the user. In the case of Table 2, for the process cartridges 6Y and 6C, the initial setting operation has not been performed (not complete) and the toner remaining amount is 100%. For the process cartridge 6M, the initial setting operation has been performed (complete) and the toner remaining amount is 80%. For the process cartridge 6K, the initial setting operation has been performed and the toner remaining amount is 40%.

When the flow chart in FIG. 4 is applied to the case in Table 2, if the load state determination unit 43 detects an overload (FIG. 3, Y in S56) and the motor 41 is stopped (FIG. 3, S57), the following occurs. The toner remaining amount determination unit 44 determines the M station, on which a driven product having a toner remaining amount of 80% or more is mounted, to be the target station (Y in S70, S71). When the process cartridge 6M is taken out, the initial setting operation is performed for the remaining process cartridges 6Y, 6C, and 6K. If the initial setting operation can be completed in this state, the two process cartridges 6Y and 6C which had not completed the initial setting operation will be completed, therefore all of the mounted process cartridges 6Y, 6C, and 6K will be completed (driven products). For this reason, after the removed process cartridge 6M (driven product) has been remounted, an initial setting operation does not need to be additionally performed.

In a case in which the load state determination unit 43 detects an overload state, the Y station on which is mounted a new cartridge of which a position is the next closest to the open/close portion 26 is determined to be the target station (N in S70, S72). When the process cartridge 6Y is taken out, the initial setting operation is performed for the remaining process cartridges 6C and 6K. In this case, after the removed new cartridge 6Y is mounted, an initial setting operation is additionally performed.

As described above, according to embodiment 2, by issuing a notification to take out a process cartridge 6 in the driven state having a toner remaining amount of a predetermined value or more and performing the initial setting operation, it is possible to reduce the frequency of performing the initial setting operation when the process cartridge 6 which has been removed once is remounted.

As described above, according to embodiment 2, in order to drive a new process cartridge 6, the load on the motor 41 that drives the plurality of process cartridges 6 can be reduced. As a result, it is possible to drive a new process cartridge having a high toner density without increasing the size of the motor that drives the plurality of process cartridges.

### Embodiment 3

An embodiment 3 differs from embodiment 1 in that a notification is issued to take out new process cartridges 6 in a descending order of toner capacity. In a case in which process cartridges 6 with large, medium and small toner capacities are present, the large-capacity product requires a larger torque to rotate the stirring member 18 than the other two types. For this reason, the torque applied to the motor 41 when one of the large-capacity process cartridges 6 is taken out is smaller than that when one of the other two types is taken out. As a result, the probability that the output torque of the motor 41 will fall within the range is increased, so that the frequency with which the process cartridges 6 need to be taken out and the initial setting operation needs to be additionally performed can be reduced. The description of contents similar to those in embodiment 1 will be omitted.

### <Determination of Target Station>

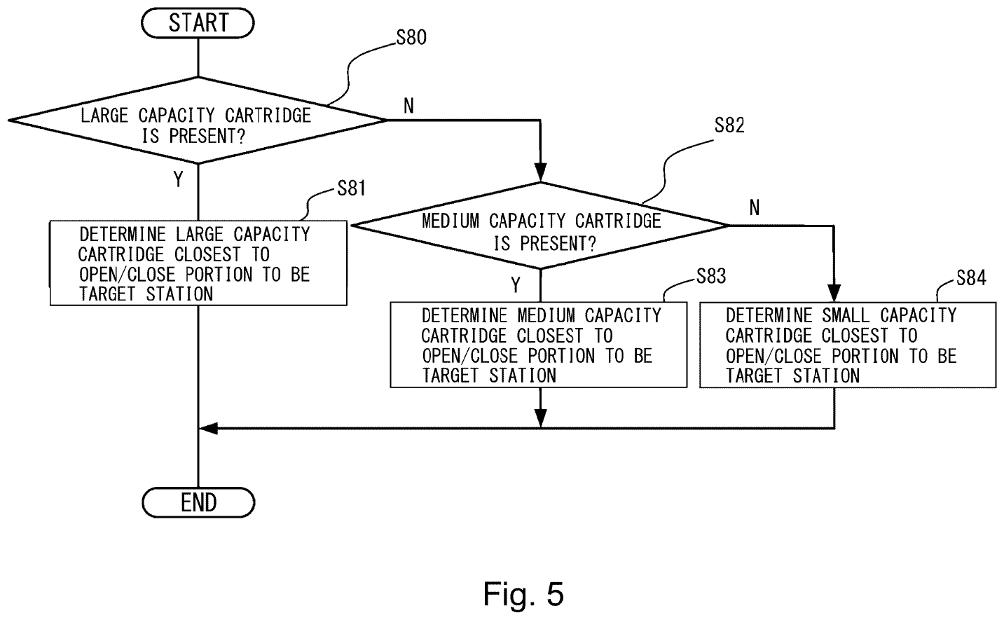

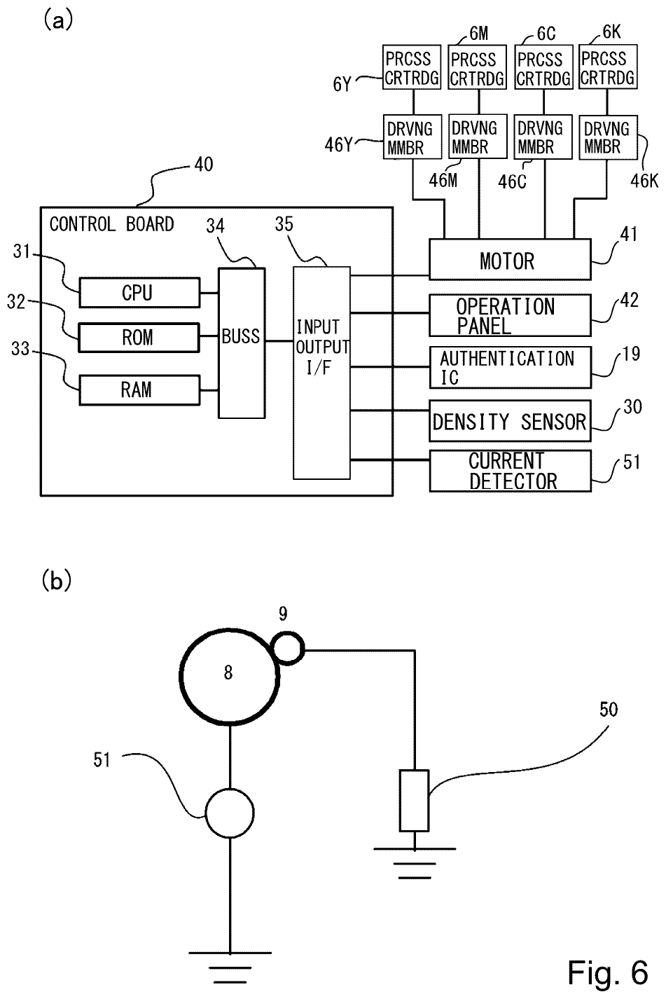

The initial setting operation in embodiment 3 differs from that in embodiment 1 in the determination method of the target station (S59 in the flow chart in FIG. 3). The determination method of the target station is determined using the flow chart in FIG. 5. If S58 in FIG. 3 determines that there is a plurality of process cartridges 6, the process in S80 in FIG. 5 is executed.

In S80, the initial control unit 45 reads data indicating toner capacity memorized in the authentication IC 19, and determines whether or not a large-capacity process cartridge 6 is present. In S80, if the initial control unit 45 determines that a large-capacity process cartridge 6 is present, the process proceeds to S81. In S81, the initial control unit 45 determines the station on which is mounted a large-capacity process cartridge (large-capacity product) of which a position is closest to the open/close portion 26 to be the target station, and ends the process. Incidentally, after this, steps S60 and onward in FIG. 3 are executed.

In S80, if the initial control unit 45 determines that a large-capacity process cartridge 6 is not present, the process proceeds to S82. In S82, the initial control unit 45 determines whether or not a medium-capacity process cartridge 6 is present. In S82, if the initial control unit 45 determines that a medium-capacity process cartridge 6 is present, the process proceeds to S83. In S83, the initial control unit 45 determines the station on which is mounted a medium-capacity process cartridge (medium-capacity product) of which a position is closest to the open/close portion 26 to be the target station, and ends the process. Incidentally, after this, steps S60 and onward in FIG. 3 are executed. In S82, if the initial control unit 45 determines that a medium-capacity process cartridge 6 is not present, the process proceeds to S84. In S84, the initial control unit 45 determines the station on which is mounted a small-capacity product of which a position is closest to the open/close portion 26 to be the target station, and ends the process. Incidentally, after this, steps S60 and onward in FIG. 3 are executed.

In embodiment 3, the initial control unit 45 determines the at least one target cartridge so that, of new cartridges mounted on the casing 1a, the at least one target cartridge includes a cartridge with the largest toner capacity.

### Specific Example

TABLE 3

| | Presence/absence of initial setting operation | Toner capacity |
|---|---|---|
| Y | Not complete | Medium |
| M | Not complete | Small |
| C | Not complete | Medium |
| K | Not complete | Large |

Table 3 shows a relationship between the implementation status of the initial setting operation in embodiment 3 and the toner capacity.

Table 3 shows an example of the implementation status of the initial setting operation and the toner capacity of the process cartridge 6 immediately after the replacement of the process cartridge 6 is notified on the operation panel 42 and the process cartridge 6 is replaced with a new cartridge by the user. In the case of Table 3, the process cartridges 6Y and 6C have a medium toner capacity, the process cartridge 6M has a small toner capacity, and the process cartridge 6K has a large toner capacity.

When the flow chart in FIG. 5 is applied to the case shown in Table 3, if the load state determination unit 43 detects an overload (FIG. 3, Y in S56) and the motor 41 is stopped (FIG. 3, S57), the following occurs. First, the station on which the large-capacity process cartridge 6K is mounted is determined to be the target station (S80, Y in S81). After the process cartridge 6K is taken out, the initial setting operation is performed for the remaining process cartridges 6Y, 6M, and 6C.

In a case in which the load state determination unit 43 detects an overload in a state in which the process cartridge 6K has been taken out, the station Y on which is mounted a medium-capacity product of which a position is closest to the open/close portion 26 is determined to be the target station (N in S80, Y in S83). After the process cartridge 6Y is taken out, the initial setting operation is performed for the remaining process cartridges 6M and 6C. In a case in which an overload is detected in a state in which the process cartridges 6Y and 6K have been taken out, the C station on which is mounted a medium-capacity cartridge of which a position is closest to the open/close portion 26 is determined to be the target station (N in S80, Y in S82, S83). When the process cartridge 6C is taken out, the initial setting operation is performed only for the remaining process cartridge 6M.

As described above, according to embodiment 3, the process cartridges 6 are taken out in a descending order of toner capacity, so that the torque applied to the motor 41 when one process cartridge 6 is taken out can be further reduced. As a result, the probability that the output torque of the motor 41 will fall within the range is increased, so that the frequency with which the process cartridges 6 need to be taken out and the initial setting operation needs to be additionally performed can be reduced.

As described above, according to embodiment 3, in order to drive a new process cartridge 6, the load on the motor 41 that drives the plurality of process cartridges 6 can be reduced. As a result, it is possible to drive a new process cartridge having a high toner density without increasing the size of the motor that drives the plurality of process cartridges.

### Embodiment 4

In an embodiment 4, controlling the process cartridge presence/absence detection if there is a station in which information cannot be read from the authentication IC 19 after the initial setting operation described in embodiments 1 to 3 is performed will be described. The process cartridge presence/absence detection is performed to detect whether or not a process cartridge 6 is mounted in a case in which the authentication IC 19 is not attached to the process cartridge. In embodiment 4, a deciding operation can be an operation in which the presence/absence of the process cartridge 6 is decided using the density sensor 30 or a current detection circuit 51 described later.

The initial control unit 45 performs the resolving operation, and does not perform the deciding operation in a case in which the initial setting operation is performed in the second state.

The image forming apparatus 1 is provided with the density sensor 30 which detects the toner image transferred onto the intermediary transfer belt 13. After performing the initial setting operation, if there is a station in which information cannot be read from the authentication IC 19, the initial control unit 45 forms a toner image (hereinafter referred to as pattern image) for detecting the process cartridge 6 on the photosensitive drum 8 of that station. Then, the initial control unit 45 performs an operation in which the pattern image that should be formed on the photosensitive drum 8 is transferred onto the intermediary transfer belt 13. The initial control unit 45 measures the amount of reflected light of the pattern image that should be formed on the intermediary transfer belt 13 using the density sensor 30. Here, since the amount of reflected light differs depending on whether or not a pattern image is present on the intermediary transfer belt 13, the initial control unit 45 can detect the presence/absence of a pattern image by using the density sensor 30. Based on the measurement result, the initial control unit 45 can detect whether or not a process cartridge is mounted even on a station in which information cannot be read from the authentication IC 19.

### <Hardware Configuration>

Part (a) of FIG. 6 is a diagram illustrating a hardware configuration of embodiment 4. The density sensor 30 and the current detection circuit 51 are connected to the input/output I/F 35, and the CPU 31 is capable of controlling the density sensor 30 and the current detection circuit 51 via the input/output I/F 35. Further, the CPU 31 can determine whether or not the process cartridge 6 is mounted based on the detection result of the density sensor 30 and the detection result of the current detection circuit 51. Incidentally, the other configurations are the same as those in part (a) of FIG. 6 of embodiment 1, therefore their descriptions will be omitted.

### <Process Cartridge Presence/Absence Detection>

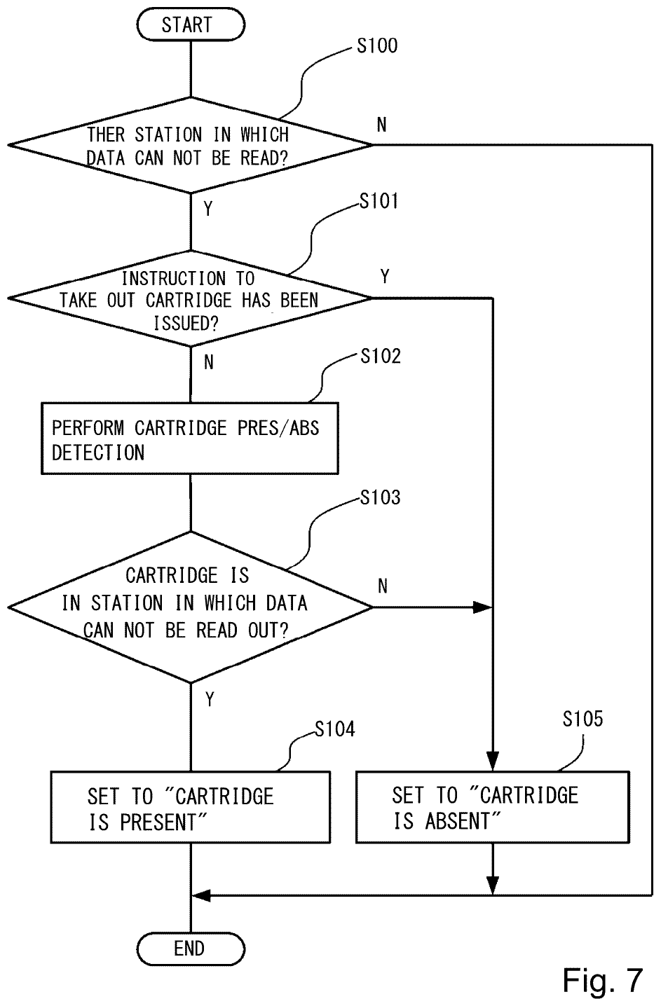

FIG. 7 is a flow chart for the process cartridge presence/absence detection in a case in which there is a station in which information cannot be read from the authentication IC 19. In S100, the initial control unit 45 determines whether or not there is a station in which information cannot be read from the authentication IC 19. In S100, if the initial control unit 45 determines that the information can be read in all stations, the flow is ended.

In S100, if the initial control unit 45 determines that there is even one station in which information cannot be read from the authentication IC 19, the process proceeds to S101. In S101, the initial control unit 45 determines whether or not an instruction to take out the process cartridge 6 (S61 in FIG. 3) has been issued. Incidentally, also in embodiment 4, if the target station presence/absence data is “1”, the initial control unit 45 determines that the instruction to take out the process cartridge 6 has been issued. In S101, if the initial control unit 45 determines that the instruction to take out the process cartridge 6 has been issued, the process proceeds to S105. In S105, the initial control unit 45 sets the station in which data cannot be read to “no process cartridge” and ends the flow.

For example, if the initial setting operation has failed and the initial setting operation is performed for the remaining process cartridges 6M, 6C, and 6K in a state in which the process cartridge 6Y has been taken out, the following occurs according to the flow chart in FIG. 7. That is, the process cartridge presence/absence detection process in S102 can be skipped. This makes it possible to reduce the time required to perform the process cartridge presence/absence detection.

In S101, if the initial control unit 45 determines that the instruction to take out the process cartridge 6 has not been issued, the process proceeds to S102. In S102, the initial control unit 45 performs the process cartridge presence/absence detection. The initial control unit 45 causes the pattern image to be formed from the station in which information cannot be read. In S103, the initial control unit 45 determines whether or not the pattern image could be measured by the density sensor 30, that is, whether or not there is a process cartridge 6 in a station in which data cannot be read.

In S103, if the initial control unit 45 determines that the process cartridge 6 is in a station in which data cannot be read, the process proceeds to S104. In S104, the initial control unit 45 sets the station to a state in which a process cartridge is present. In S103, if the initial control unit 45 determines that the station in which data cannot be read does not have a process cartridge 6, the process proceeds to S105. In S105, the initial control unit 45 sets the station in which data cannot be read to no process cartridge, and ends the flow.

As described above, according to embodiment 4, in order to drive a new process cartridge 6, the load on the motor 41 that drives the plurality of process cartridges 6 can be reduced. Further, if the initial setting operation fails and the initial setting operation is performed again in a state in which the process cartridge 6 has been taken out, the time required to perform the process cartridge presence/absence detection can be reduced by skipping the process cartridge presence/absence detection.

### Modification

In embodiment 4, the configuration is such that the process cartridge presence/absence detection is performed by the density sensor 30, but the process cartridge presence/absence detection in S102 is not limited to this. Part (b) of FIG. 6 is a principal part schematic view showing a charging circuit 50 which is an applying means and the current detection circuit 51 as a current detecting means. The charging circuit 50 applies a voltage to the charging roller 9. The current detection circuit 51 detects the current flowing through the photosensitive drum 8. With this configuration, the current detection circuit 51 which detects a value of current in the photosensitive drum 8 may perform the process cartridge presence/absence detection.

That is, a voltage for detecting the process cartridge is applied to the charging roller 9 by the charging circuit 50, and a voltage is applied from the charging roller 9 to the photosensitive drum 8, thereby uniformly charging the surface of the photosensitive drum 8. Then, depending on whether or not the current detection circuit 51 can detect a value of current equivalent to that voltage, it is possible to detect the presence/absence of a process cartridge 6.

### Other Embodiments

The present invention can also be realized by supplying a program that realizes one or more functions of the above-described embodiments to a system or device via a network or memory medium, and having one or more processors in a computer of the system or device read and execute the program. Further, the present invention can also be realized by a circuit (for example, ASIC) that realizes one or more functions.

According to the present invention, in order to drive a new process cartridge, the load on the motor that drives the plurality of process cartridges can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-108126 filed on Jul. 4, 2024, which is hereby incorporated by reference herein in its entirety.

What is claimed is:

1. An image forming apparatus on which cartridges are dismountably mounted and capable of performing image forming operation to a recording material, the image forming apparatus comprising:
a casing on which the cartridges are dismountably mounted;
a motor;
driving members configured to be driven by the motor, each of the driving members being engaged with each of the cartridges and being configured to drive each of the cartridges; and
a controller configured to control the motor and perform an initial operation in which the driving members are driven by the motor in a state in which at least one new cartridge is mounted on the casing before performing the image forming operation,
wherein the controller is capable of performing the initial operation in a first state in which the same number of the cartridges as that of the driving members are mounted on the casing and in a second state in which a smaller number of the cartridges than that of the driving members are mounted on the casing,
wherein the controller performs a resolving operation to stop the initial operation when an overload state of the motor is detected during performing the initial operation in a state in which at least two new cartridges are mounted on the casing, to determine at least one target cartridge, and to display information relating to taking out the at least one target cartridge from the casing to a display portion, and
wherein the controller determines the at least one target cartridge so that at least one new cartridge is left in the casing in a case in which the at least one target cartridge is taken out from the casing.

2. The image forming apparatus according to claim 1, wherein the controller is capable of performing the resolving operation in a case in which the overload state is detected during performing the initial operation in the first state and in a case in which the overload state is detected during performing the initial operation in the second state.

3. The image forming apparatus according to claim 1, wherein the controller determines the at least one target cartridge so that the at least one target cartridge includes a part of the at least two new cartridges in the case in which the overload state of the motor is detected during performing the initial operation in a state in which the two new cartridges and a cartridge which has completed the initial operation are mounted on the casing.

4. The image forming apparatus according to claim 1, wherein the controller determines the at least one target cartridge so that the at least one target cartridge includes a cartridge in which the initial operation is completed and of which a toner remaining amount is a predetermined value or more.

5. The image forming apparatus according to claim 1, further comprising an opening configured to permit mounting and dismounting of the cartridges;
an open/close portion movable to a closing position for closing the opening and an opening position for exposing the opening; and
a tray configured to support the cartridges and capable of drawing out the cartridges from the opening in an order closer to the opening,
wherein the controller determines the at least one target cartridge so that the at least one target cartridge includes a cartridge of which a position is closest to the open/close portion.

6. The image forming apparatus according to claim 1, wherein the controller determines the at least one target cartridge in a descending order of toner capacity of new cartridges mounted on the casing.

7. The image forming apparatus according to claim 1, wherein in a case in which the at least one target cartridge includes a part of the two new cartridges, the controller displays information relating to mounting of a part of the at least two new cartridges on the casing to the display portion after performing the initial operation in a state in which the at least one target cartridge is taken out from the casing, and performs the initial operation in a state in which a part of the at least two new cartridges is mounted on the casing.

8. The image forming apparatus according to claim 1, wherein the overload state is detected in a case in which a number of rotations of the motor continuously becomes less than a predetermined value for a predetermined time.

9. The image forming apparatus according to claim 1, wherein the overload state is detected in a case in which a value of current flowing through the motor continuously becomes a predetermined value or more for a predetermined time.

10. The image forming apparatus according to claim 1, wherein the controller performs a display operation to display information relating to a failure of the motor to the display portion in a case in which the overload state is detected during performing the initial operation in a state in which the at least one new cartridge is mounted on the casing.

11. The image forming apparatus according to claim 1, wherein each of the cartridges includes a photosensitive member, a developing roller configured to apply toner to the photosensitive member, a toner accommodating portion configured to accommodate the toner to be applied by the developing roller to the photosensitive member and a sealing member configured to seal a supply port of the toner from the toner accommodating portion to the developing roller so as not to supply the toner from the toner accommodating portion to the developing roller, and
wherein the initial operation includes an unsealing operation in which the sealing member is unsealed by a drive of the motor being transmitted.

12. The image forming apparatus according to claim 1, wherein each of the cartridges includes a stirring member configured to stir the toner accommodated in the toner accommodating portion, and
wherein the initial operation includes a stirring operation in which the toner accommodated in the toner accommodating portion is stirred by the stirring member by a drive of the motor being transmitted when the new cartridge is mounted on the casing.

13. The image forming apparatus according to claim 1, wherein the controller is capable of performing a judging operation in which whether or not the image forming apparatus is in the first state, and
wherein in a case in which the resolving operation is performed, the controller performs the judging operation after performing the initial operation.

14. The image forming apparatus according to claim 11, further comprising an intermediary transfer member to which a toner image born on the photosensitive member is transferred; and
a sensor configured to detect the intermediary transfer member or the toner image on the intermediary transfer member, and
wherein the controller is capable of performing a deciding operation in which a presence/absence of the cartridge is decided by performing an operation in which the toner image is formed on the intermediary transfer member and detecting on the intermediary transfer member by the sensor, and does not perform the deciding operation when the resolving operation is performed.

15. The image forming apparatus according to claim 11, further comprising a charging means configured to charge the photosensitive member;
an applying means configured to apply a voltage to the charging means; and
a current detecting means configured to detect a current flowing through the photosensitive member,
wherein the controller is capable of performing a deciding operation in which a presence/absence of the cartridge is decided by applying the voltage to the charging means and detecting the current by the current detecting means, and does not perform the deciding operation when the resolving operation is performed.

16. The image forming apparatus according to claim 1, wherein each of the cartridges includes a memory member configured to memorize information relating to each of the cartridges.

17. The image forming apparatus according to claim 16, wherein the memory member memorizes the information relating to whether or not each of the cartridges is a new one.
